(19) United States
(12) Patent Application Publication
(10) Pub. No.: US 2002/0159665 A1
(43) Pub. Date: Oct. 31, 2002

(54) Optical emitter including a modulator comprising a plurality of modulator units

(75) Inventors: Jean-Rene Burie, Bruyeres Le Chatel (FR); Philippe Andre, Toulouse (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/132,162

(22) Filed: Apr. 26, 2002

(30) Foreign Application Priority Data
Apr. 27, 2001 (FR) 01 05 758

(51) Int. Cl. G02F 1/01

(52) U.S. Cl. 385/1

(57) ABSTRACT

An optical emitter includes an electro-optical modulator which comprises N modulator units optically coupled in series and having N separate control electrodes. The modulator is controlled by an electronic control circuit which delivers N identical electrical signals at N separate outputs, each of which is connected to a respective control electrode of one of the N modulator units.

### CROSS-REFERENCE TO RELATED APPLICATIONS

This application is based on French Patent Application No. 01 05 758 filed Apr. 27, 2001, the disclosure of which is hereby incorporated by reference thereto in its entirety, and the priority of which is hereby claimed under 35 U.S.C. §119.

### BACKGROUND OF THE INVENTION

1. Field of the invention

The present invention relates to high bit rate optical transmission, in which it is important to maximize optical component bandwidth. To this end, in the case of an optical emitter, for example a laser, one solution is to reduce the intrinsic capacitance of the optical modulator that is generally associated with said emitter. The invention is more specifically concerned with monolithic integrated optical components, i.e. components fabricated on a single integrated circuit chip.

2. Description of the Prior Art

There are various types of optical modulator. Electro-absorption modulators amplitude-modulate the optical wave by displacing the absorption peak of the material constituting the waveguide by means of a control voltage. Mach-Zender modulators, comprising two branches, modulate the phase of the optical wave in at least one branch to produce interference at the output of the two branches. A control voltage is applied to at least one branch, the other of which can be grounded.

An optical electro-absorption modulator (EAM) is shown diagrammatically in FIG. 1. This kind of modulator is well known in the art. It comprises a waveguide 11 taking the form of a ridge (mesa) on a semiconductor material (for example InP) substrate 10. The waveguide 11 includes an intrinsic semiconductor material active layer 12 between two semiconductor material layers each doped with a different type of carrier. A control voltage is applied to the guide 11 to displace the absorption peak of the waveguide 11 toward the working wavelength and amplitude-modulates the wave passing through the guide.

The intrinsic capacitance C of an EAM is defined by the following equation:

C=εε₀(I×L)/e

in which I and L are respectively the width and the length of the waveguide 11 of the modulator, e is the thickness of the active layer 12 of the waveguide 11, and ε and ε₀ are dielectric constants.

To reduce the capacitance C, it is necessary either to reduce I or L or to increase e. Physical and optical constraints apply to these parameters.

First of all, the width I of the wavelength 11 is fixed by the optical constraints on propagation of waves in the guide 11. Next, the thickness e of the active layer 12 is fixed by fabrication constraints, to be more specific epitaxy constraints. Moreover, by increasing the thickness e, the efficiency of modulation is reduced, which is not desirable. Finally, the length L of the waveguide 11 can be reduced to reduce the capacitance C. However, reducing the length L reduces the absorption, thereby degrading the performance of the component.

In the case of a discrete Mach-Zender modulator, the problem of reducing the capacitance is the same for each branch, and the solution proposed by the present invention is applied in the same manner.

The object of the present invention is to alleviate the drawbacks cited, i.e. to reduce the capacitance of a modulator without degrading its optical performance.

To this end, the invention proposes to produce an optical emitter including an electro-optical modulator comprising a plurality of modulator units each controlled by the same electrical control signal, each unit having a reduced waveguide length, and therefore a commensurately reduced capacitance.

### SUMMARY OF THE INVENTION

To be more specific, the invention provides an optical emitter including an electro-optical modulator which comprises N modulator units optically coupled in series and having N separate control electrodes and is controlled by an electronic control circuit which is adapted to deliver N identical electrical signals at N separate outputs each of which is connected to a respective control electrode of one of the N modulator units. Depending on the application, the modulator units are either electro-absorption modulators or discrete Mach-Zender modulators.

In respective different embodiments the electronic control circuit is a multiplexer with M inputs and N synchronized outputs and an amplifier with one input or M inputs and N synchronized outputs.

According to an advantageous feature of the invention the optical emitter takes the form of a monolithic integrated component.

According to another feature of the invention the electronic control circuit is integrated into the electro-optical modulator.

Other features and advantages of the invention will become clearly apparent after reading the following description, which is given by way of illustrative and non-limiting example and with reference to the accompanying drawings.

### BRIEF DESCRIPTION OF THE DRAWINGS

FIG. 1, already described, is a diagram of a prior art electro-absorption modulator.

FIG. 2 shows diagrammatically the structure of an optical emitter according to the present invention.

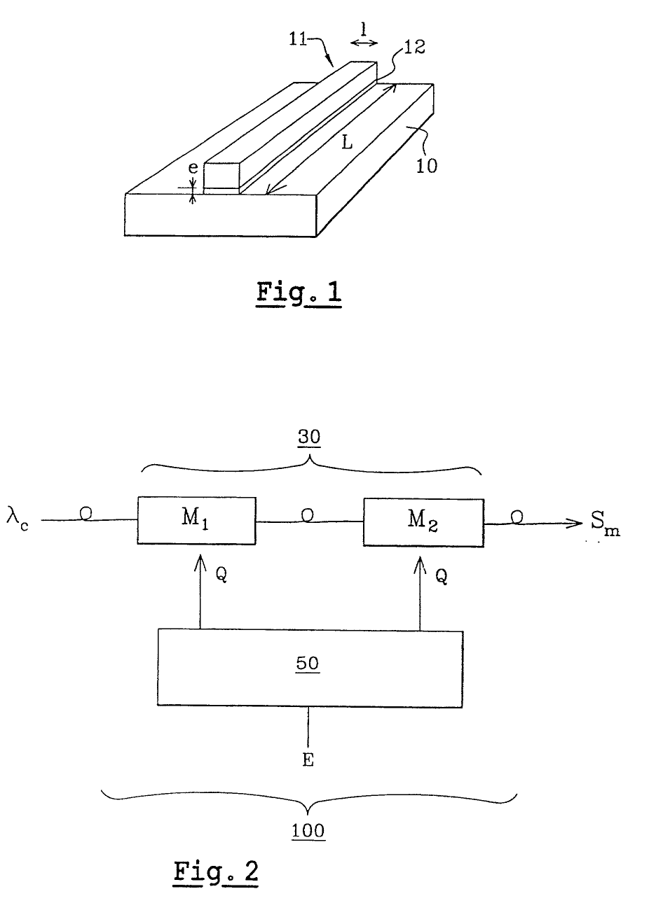

### DETAILED DESCRIPTION OF THE PREFERRED EMBODIMENT

The objective of the present invention is to provide an optical emitter including an electro-optical modulator having the required high bit rate data transmission performance.

As already indicated, one solution to reducing the capacitance of a modulator is to reduce the length of its waveguide.

The present invention therefore proposes to provide a modulator comprising a plurality of modulator units M_{N} of reduced length, and therefore of reduced capacitance, and to place them optically in series to alleviate the disadvantage of the reduced absorption of the optical wave propagating in the modulator. The global absorption of the optical wave emitted by the emitter is then the sum of the absorptions in each of the modulator units placed in series, and the bandwidth is widened because of the reduced intrinsic capacitance of each unit.

FIG. 2 is a diagram showing the implementation of the invention. In this example there are two modulator units M₁ and M₂, but the invention applies in the same manner to any number N of modulator units disposed in series.

An emitter 100, for example a laser, must emit a modulated optical signal Sₘ from the output, at wavelength λ_{c}, of a continuous source. The emitter 100 includes an electro-optical modulator 30 comprising N (N=2 in this example) modulator units M_{N} (M₁, M₂ in this example) disposed optically in series.

In a preferred embodiment, the modulator units M_{N} are electro-absorption modulators (EAM). However, the invention applies equally to modulator units MN comprising discrete Mach-Zender (MZ) modulators.

An electrical control signal Q is applied to the waveguide of each modulator unit M_{N}. The electrical control signals Q for each modulator unit M_{N} must be identical, with a time-delay matched to the time-delay of the light signal between the units M_{N}. The modulator units M_{N} of the modulator 30 are thus electrically disposed in parallel.

To this end, the modulator 30 is controlled by an electronic circuit 50 with an input E and N synchronized outputs Q. This kind of control circuit 50 is known in the art and can readily be produced by the person skilled in the art. For example, it can be a multiplexer with one input and N outputs, or an amplifier circuit receiving an electrical input signal with a low amplitude (0.4 Volts, for example) and producing at its output N synchronized electrical control signals Q with an amplitude from 3 to 4 Volts, for example. An example of this kind of amplifier circuit is described in the publication “Short optical pulse generation at 20 GHz repetition rate using integrated laser—modulators—amplifier” by G. Martin, E. Vergnol, A. Carenco, and A. Ramdane, ECOC 2000, Munich, September 2000.

According to the invention, the modulator 30 and the electronic control circuit 50 are integrated on the same integrated circuit chip. In particular, the modulator can be integrated into the emitter 100. This monolithic integration of the optical component 100 avoids the problems of optical wave phase shift. This monolithic integration of the modulator units M_{N} with the emitter is possible because each modulator unit is controlled by the same parallel electrical signal, enabling the use of a common ground electrode for the modulator units and the emitter.

Thus, in the embodiment of the invention shown, a modulator of length L and capacitance C is replaced by two modulator units M₁ and M₂ of length L/2. As a result the overall length of the modulator 30 is 2×L/2, that is to say L, and the absorption is therefore not penalized, but the intrinsic capacitance of the modulator M is reduced to C/2 by the series connection of the two modulator units M₁ and M₂, and the bandwidth of the emitter 100 is therefore enlarged.

There is claimed:

1. An optical emitter including an electro-optical modulator which comprises N modulator units optically coupled in series and having N separate control electrodes and is controlled by an electronic control circuit which is adapted to deliver N identical electrical signals at N separate outputs each of which is connected to a respective control electrode of one of said N modulator units.

2. The optical emitter claimed in claim 1 wherein said modulator units are electro-absorption modulators.

3. The optical emitter claimed in claim 1 wherein said modulator units are discrete Mach-Zender modulators.

4. The optical emitter claimed in claim 1 wherein said electronic control circuit is a multiplexer with M inputs and N synchronized outputs.

5. The optical emitter claimed in claim 1 wherein said electronic control circuit is an amplifier with one input and N synchronized outputs.

6. The optical emitter claimed in claim 1 when it takes the form of a monolithic integrated component.

7. The optical emitter claimed in claim 1 wherein said electronic control circuit is integrated into said electro-optical modulator.
